(19) United States
(12) Patent Application Publication
(10) Pub. No.: US 2020/0223336 A1
(43) Pub. Date: Jul. 16, 2020

(54) SEAT PROTECTORS AND RELATED METHODS

(71) Applicant: ADC Solutions Auto, LLC, Costa Mesa, CA (US)

(72) Inventor: Joseph R. Conti, Los Angeles, CA (US)

(21) Appl. No.: 16/743,800

(22) Filed: Jan. 15, 2020

Related U.S. Application Data
(60) Provisional application No. 62/792,692, filed on Jan. 15, 2019.

(51) Int. Cl. B60N 2/60; A47C 31/11; G09F 23/00

(52) U.S. Cl. CPC B60N 2/6063; G09F 23/00; A47C 31/113

(57) ABSTRACT

Seat protectors configured to be positioned on seats, such as vehicle seats.

### RELATED APPLICATION

This application claims priority to copending U.S. Provisional Patent Application No. 62/792,692 entitled Seat Protectors and Related Methods filed Jan. 15, 2019, the entire disclosure of which is expressly incorporated herein by reference.

### FIELD OF THE INVENTION

The present invention relates generally to protective covers for seats, such as vehicle seats.

### BACKGROUND

Pursuant to 37 CFR 1.71(e), this patent document contains material which is subject to copyright protection and the owner of this patent document reserves all copyright rights whatsoever.

### SUMMARY

In accordance with the present invention, there is provided a seat protector which generally comprises: a mat having a upper surface, a lower surface, a top end, a bottom end and side edges; and a head rest engaging member attached to the mat at or near the top end; wherein the seat protector is alternately disposable in a rolled configuration and an unrolled configuration; and, when in the unrolled configuration, the seat protector is positionable in an operative position on a seat such that a head rest of the seat is engaged by the head rest engaging member, the lower surface of an upper portion of the mat is juxtaposed to or in contact with an upstanding backrest portion of the seat; and the lower surface of a lower portion of the mat is juxtaposed to or in contact with a seating portion of the seat. Seat protectors of the present invention may be configured such that, when positioned on a vehicle seat, they do not obstruct or interfere with functioning of crash-deployed air bags or other functional components of the vehicle. Seat protectors of the present invention may be configured such that, when positioned on a vehicle seat, they do not block or substantially interfere with access to or functioning of arm rests, glove boxes/storage compartments, seat adjustment controls/mechanisms, or other apparatus located within the vehicle's passenger compartment. Seat protectors of the present invention may be constructed so as to be waterproof or substantially impervious to liquid. The mat portion of a seat protector of the present invention may have seams or joinders formed therein, or it may be of seamless or joinderless construction. Seat protectors of the present invention may be provided with one or more attachment member(s) (e.g., loop(s), strap(s), hook(s), etc.) useable for holding the seat protector in an operative position on a seat. Optionally, such attachment member(s) may alternatively be useable to hold or retail the seat protector in a stowable (e.g., rolled or folded) configuration when not in use. Seat protectors of the present invention may optionally be provided with a sleeve member that is positionable around the seat member when the seat member in a stowable (e.g., folded or rolled) configuration Such sleeve member may, in some embodiments, bear labeling or other printed information, such as labeling for point of sale retail viewing. Optionally or alternatively, such sleeve member may be constructed so as to be reusable as a case or retainer sleeve for holding the seat protector in a stowable (e.g., rolled or folded) configuration when not in use.

Further in accordance with the present invention, there are provided methods for installing, removing and using seat protectors of the present invention, as disclosed herein.

Still further in accordance with the invention, there is provided

Still further aspects and details of the present invention will be understood upon reading of the detailed description and examples set forth herebelow.

### BRIEF DESCRIPTION OF THE DRAWINGS

The following figure is included in this patent application and referenced in the following Detailed Description and Examples. This figure is intended only to illustrate certain aspects or embodiments of the invention and does not limit the invention in any way:

The examples or embodiments of the invention, and shall not limit the scope of the invention in any way.

FIG. 1 is a front view or one embodiment of a seat protector of the present invention.

FIG. 2 is a rear view of the seat protector embodiment shown in FIG. 1.

FIG. 3 is a cross sectional view through a portion of the seat protector embodiment shown in FIG. 1.

FIG. 4 is a front perspective view of the seat protector embodiment of FIG. 1 installed on a vehicle seat.

FIG. 5 is a partial rear perspective view of the seat protector embodiment of FIG. 1 installed on a vehicle seat.

FIG. 6 is a partial front view showing optional debossing on the front surface of the seat protector embodiment shown in FIG. 1.

FIG. 7 shows the seat protector embodiment of FIG. 1 in a rolled configuration in combination with an optional sleeve.

### DETAILED DESCRIPTION

The following detailed description and the accompanying drawings to which it refers are intended to describe some, but not necessarily all, examples or embodiments of the invention. The described embodiments are to be considered in all respects only as illustrative and not restrictive. The contents of this detailed description and the accompanying drawings do not limit the scope of the invention in any way.

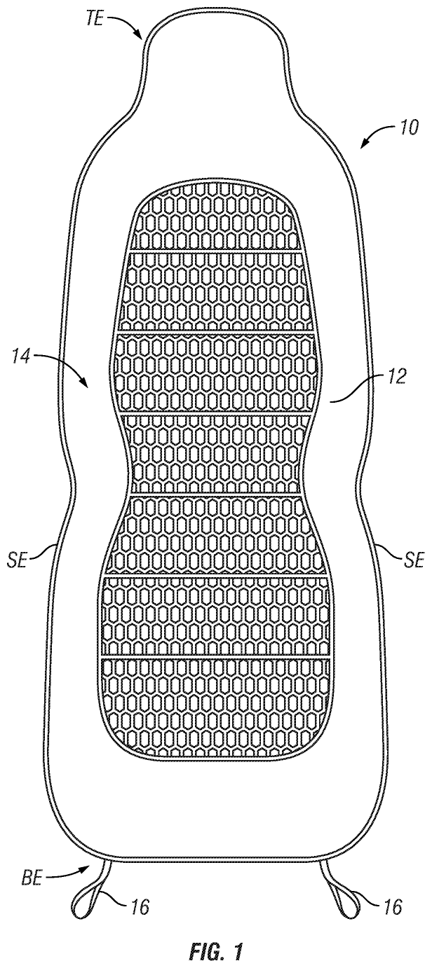

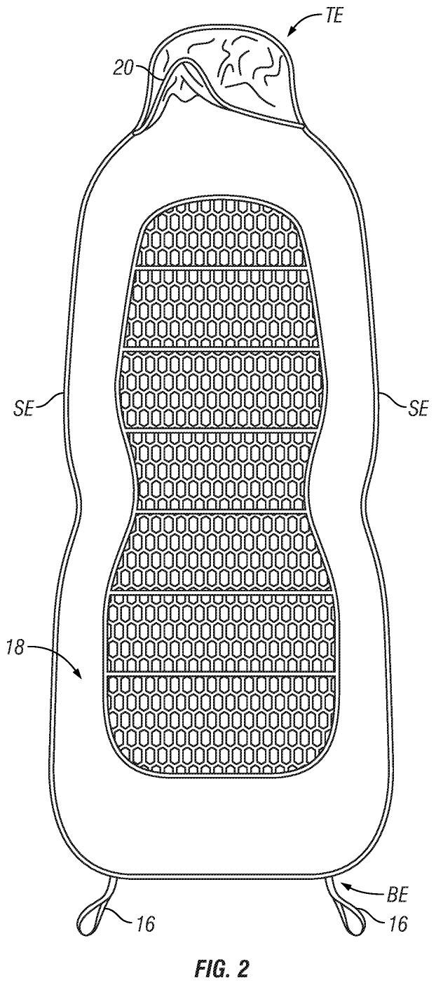

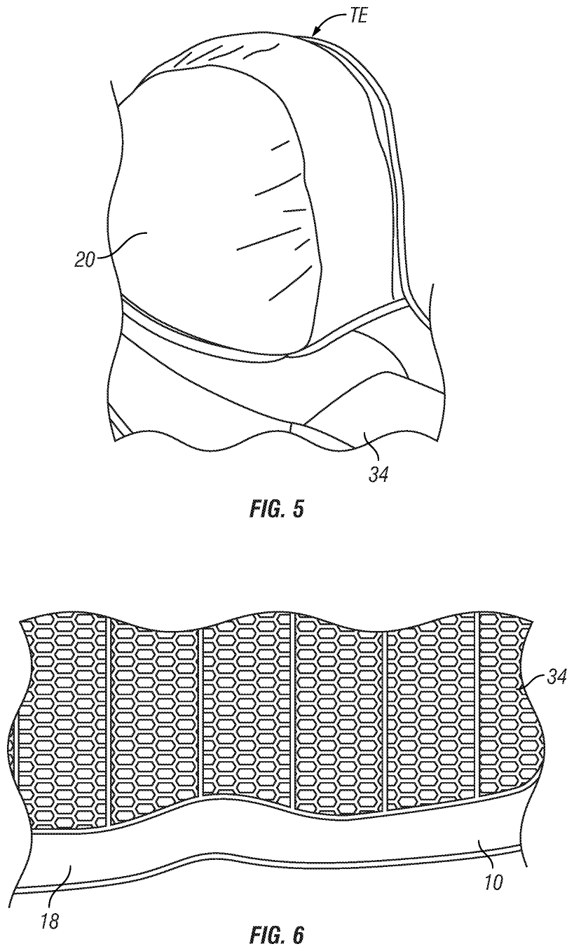

The following description describes the present invention with reference to certain non-limiting embodiments or examples as shown in the accompanying FIGS. 1 through 7.

In the non-limiting example shown, the seat protector 10 comprises a mat 12 having a upper surface 14, a lower surface 18, a top end TE, a bottom end BE and side edges SE. In the non-limiting example shown, a head rest engaging member 20 is attached to the mat 12 at or near the top end TE. The portion of the top end TE to which the head rest engaging member 20 is attached may be narrower than other portion of the mat 12 so as to approximate the shape and size of a vehicle seat head rest. In the non-limiting example shown the head rest engaging member 20 may comprise a panel of fabric or net material affixed to the mat 12 in a manner that forms a head rest receiving pocket between the bottom surface 18 of the mat 12 and that panel of fabric or net material. All of part of the head rest attachment member 20 may be elastic so that it will elastically contract around or grip the head rest. Various alternative designs may also be employed for the headrest engaging member. For example, rather than a pocket that is fitted to or fully covers the headrest, in some embodiments, the seat cover 10 may have a portion that is configured to wrap around the headrest, thereby providing protection for the headrest.

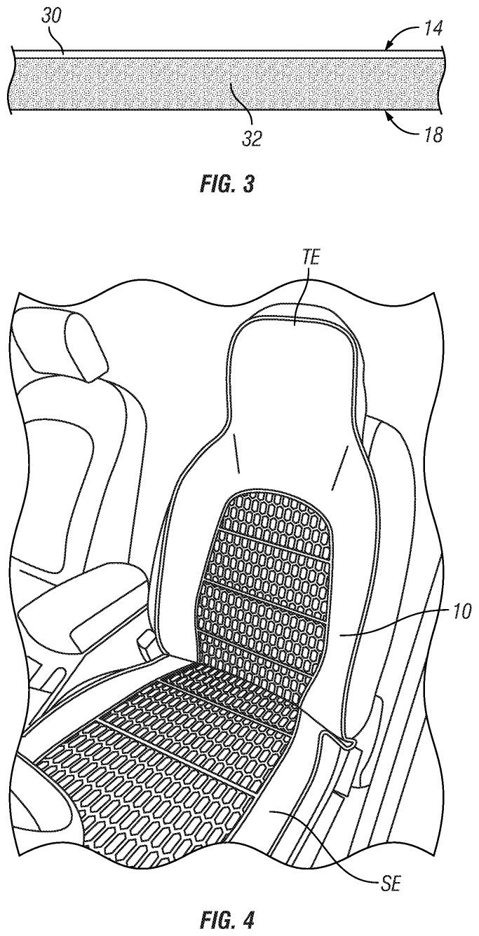

The mat 12 may have a layered construction. For example, as seen in FIG. 3, the mat may comprise fabric layer 30 (e.g., neoprene or other suitable material) and an elastomeric layer 32 (e.g., SBR rubber or other suitable material). The fabric layer 30 may be disposed on an upper side of the elastomeric layer 32. Any suitable types of elastomeric and fabric materials may be used. Additional layers may also be included.

In some embodiments each of the layers 30, 32 of the mat 12 may be a single piece, thereby providing a mat 12 that is devoid of seams or joinders and is substantially impervious to water or other fluids. This aspect of the invention may be particularly advantageous when the seat protector 10 is used to protect vehicle seats when passengers are wearing wet beachwear or other wet clothing.

Seat protectors 10 of the present invention may be alternately disposable in a stowable (e.g., rolled or folded) configuration) and an operative (e.g., unrolled or unfolded) configuration. In the non-limiting example shown in FIGS. 1 through 7, the seat protector 10 is alternately disposed in a rolled configuration or an unrolled configuration. When in the unrolled configuration, the seat protector 10 is positionable in an operative position on a seat (for example, a vehicle seat) such that: i) a head rest of the seat is engaged by the head rest engaging member 20; ii) the lower surface 18 of an upper portion of the mat 12 is in contact with an upstanding backrest portion of the seat; and iii) the lower surface 18 of a lower portion of the mat 12 is in contact with a seating portion of the seat. An example of the “seating portion’ is shown in Appendix A. The term “seating portion” as used herein includes the portion of a seat that extends at an angle relative to a backrest of the seat or supports most of the weight of a human being seated on the seat.

The seat protector 10 may include one or more attachment member(s) 16 useable to secure the seat protector in the operative position on a seat. Such attachment member(s) may be configured to engage or attach to portions of the seat or other objects located near the seat. For example, when used on a vehicle seat, the attachment member(s) may be configured to engage or attach to brackets, bars, seat adjustment apparatus or other components located on or under the vehicle seat of on other attachment points (e.g., projections, hooks, carpeting, adhesive-attached member(s), etc.) located on the vehicle near the seat, such as on the vehicle floor and/or center console. Optionally, the attachment member(s) 16 or other separate retaining members may be configured for placement around the rolled seat protector 10 to maintaining the seat protector 10 in the rolled configuration when not in use. For example, the attachment member(s) 16 (or other separate retaining members) may comprise elongate cords, bands, strips, straps or other members that can be tied around the rolled seat protector thereby preventing it from inadvertently unrolling. Alternatively, the attachment member(s) 16 may comprise elastic loops which pay be placed around the rolled seat protector 10 to hold the seat protector 10 in a rolled configuration. In some embodiments, the attachment members(s) 16 or other retaining members may be configured to maintain the seat protector 10 a rolled configuration that has a length of about 20 to 22 inches or less and a diameter of about 3 to 4 inches or less.

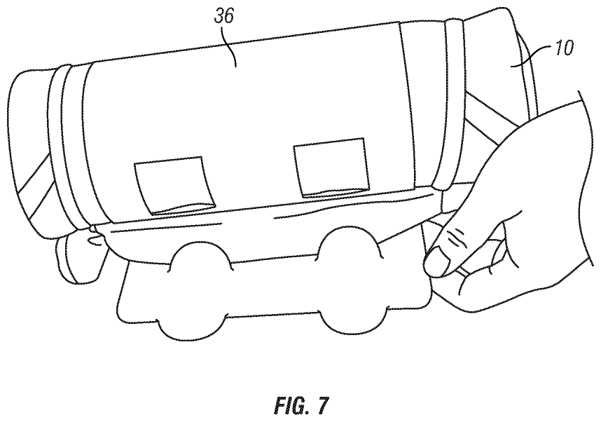

As shown in FIG. 6, a texturing process such as debossing or any other suitable process (e.g., embossing) may optionally be applied to form a textured area 34 on the mat 12. As seen in FIG. 1, the textured area 34 may extend over a portion of the front surface of the mat 12 on which a human's body would typically rest when seated on a seat that is covered with the seat protector 10.

As shown in FIG. 7, the seat protector 10 may be sold and/or displayed at a point of sale while in its rolled configuration with a label or labeling sleeve 36 placed around the rolled seat protector 10. Optionally, a sleeve 36 may be used, along with or as an alternative to the attachment members 16, to retain the seat protector in a rolled configuration for storage when not in use. If intended for repeated use during storage of the seat protector 109, the sleeve 36 may optionally be constructed of plastic or other reusable material. When constructed as a reusable item, the sleeve 36 may then be used to retain the seat protector 10 in the rolled configuration when not in use, as an alternative to, or in addition to, placement of the attachment member(s) 16 around the rolled seat protector 10, as described above.

It is to be appreciated that, although the invention has been described hereabove with reference to certain examples or embodiments of the invention, various additions, deletions, alterations and modifications may be made to those described examples and embodiments without departing from the intended spirit and scope of the invention. For example, any elements, steps, members, components, compositions, reactants, parts or portions of one embodiment or example may be incorporated into or used with another embodiment or example, unless otherwise specified or unless doing so would render that embodiment or example unsuitable for its intended use. Also, where the steps of a method or process have been described or listed in a particular order, the order of such steps may be changed unless otherwise specified or unless doing so would render the method or process unsuitable for its intended purpose. Additionally, the elements, steps, members, components, compositions, reactants, parts or portions of any invention or example described herein may optionally exist or be utilized in the absence or substantial absence of any other element, step, member, component, composition, reactant, part or portion unless otherwise noted. All reasonable additions, deletions, modifications and alterations are to be considered equivalents of the described examples and embodiments and are to be included within the scope of the following claims.

What is claimed is:

1. A seat protector comprising:
a mat having a upper surface, a lower surface, a top end, a bottom end and side edges; and
a head rest engaging member at or near the top end;
wherein the seat protector is alternately disposable in a rolled configuration and an unrolled configuration; and,
when in the unrolled configuration, the seat protector is positionable in an operative position on a seat such that:
i) a head rest of the seat is engaged by the head rest engaging member;
ii) the lower surface of an upper portion of the mat is juxtaposed to or in contact with an upstanding backrest portion of the seat; and
iii) the lower surface of a lower portion of the mat is juxtaposed to or in contact with a seating portion of the seat.

2. A seat protector according to claim 1 configured for placement on a vehicle seat such that, when positioned on the vehicle seat, the seat protector will not block or substantially interfere with access to or functioning of arm rests, glove boxes/storage compartments, seat adjustment controls/mechanisms, or other apparatus located within the vehicle's passenger compartment.

3. A seat protector according to claim 1 wherein the mat is waterproof or substantially impervious to liquid.

4. A seat protector according to claim 3 wherein the mat is of seamless construction.

5. A seat protector according to claim 1 further comprising at least one attachment member that is/are useable for holding the seat protector in place on a seat.

6. A seat protector according to claim 5 wherein the attachment member(s) is/are also useable to hold the seat protector in a rolled, folded or otherwise stowable configuration when not in use.

7. A system comprising a seat protector according to claim 1 in combination with a sleeve member configured for placement around the seat protector when the seat protector is in a rolled, folded or otherwise stowable configuration.

8. A system according to claim 7 wherein the sleeve member bears labeling or printed information.

9. A system according to claim 7 wherein the sleeve member is reusable.

10. A seat protector according to claim 1 wherein the mat comprises at least an elastomeric layer and a fabric layer, the fabric layer being disposed on an upper side of the elastomeric layer; and

11. A seat protector according to claim 1 wherein the headrest engaging member comprises a pocket within which a headrest inserts.

12. A seat protector according to claim 1 wherein the headrest engaging member comprises flexible fabric having a top edge attached to the top end of the mat, a right side edge attached a one side edge of the mat, a left side edge attached to another side edge of the mat and a bottom edge that is unattached to the mat.

13. A seat protector according to claim 1 wherein the headrest engaging member is configured to wrap around a headrest.

14. A seat protector according to claim 1, further comprising at least one attachment member configured to secure the seat protector in said operative position on the seat.

15. A seat protector according to claim 13 wherein the attachment member(s) is/are disposable around the seat protector when the seat protector is disposed in the rolled configuration to thereby maintain the seat protector in the rolled configuration.

16. A seat protector according to claim 13 wherein the attachment members comprise loops of elastic material.

17. A seat protector according to claim 1 wherein the fabric layer comprises a neoprene fabric.

18. A system comprising a seat protector according to claim 1 in combination with a seat, wherein the seat protector is disposed in said operative position on the seat.

19. A system according to claim 18 wherein the seat comprises a vehicle seat.

20. A method for using a seat protector according to claim 1, said method comprising the steps of:
causing the seat protector to be disposed in the unrolled configuration; and
placing the seat protector in said operative position on the seat.

21. A method according to claim 20 wherein the seat protector includes attachment members which attach to the seat or to an object near the seat to secure the seat protector in said operative position on the seat and wherein the method further comprises the step of:
attaching the attachment members to the seat or an object near the seat so as to secure the seat protector in said operative position on the seat.

22. A method according to claim 20 further comprising the steps of:
removing the seat protector from the seat; and
causing the seat protector to become disposed in the rolled configuration.

23. A method according to claim 22 further comprising the steps of:
causing the attachment members to become detached from the seat or portion(s);
removing the seat protector from the seat;
causing the seat protector to become disposed in the rolled configuration; and;
causing the attachment members to become disposed around the seat protector to thereby maintain the seat protector in the rolled configuration.

24. A method according to claim 20 wherein the seat comprises a vehicle seat.
